(19) United States
(12) Patent Application Publication
(10) Pub. No.: US 2016/0234808 A1
(43) Pub. Date: Aug. 11, 2016

(54) Wireless Device, Node and Methods Therein for Deciding Whether or Not to Activate a WLAN Interface

(71) Applicant: Telefonaktiebolaget L M Ericsson (publ), Stockholm (SE)

(72) Inventors: Icaro L. J. da Silva, Bromma (SE); Filip Mestanov, Sollentuna (SE); Oumer Teyeb, Solna (SE); Jari Vikberg, Jarna (SE)

(21) Appl. No.: 14/423,479

(22) PCT Filed: Feb. 11, 2015
(86) PCT No.: PCT/SE2015/050164

§ 371 Date: Feb. 24, 2015

(51) Int. Cl. H04W 72/02; H04W 16/14

(52) U.S. Cl. CPC H04W 72/02; H04W 16/14; H04W 84/12

(57) ABSTRACT

A method performed by a wireless device for deciding whether or not to activate a Wireless Local Area Network, WLAN, access, interface, WLAN interface, for data traffic is provided. The wireless device comprises a cellular radio access interface towards a node in a cellular network, cellular interface, and the WLAN interface towards an Access Point, AP, in a WLAN. The wireless device receives (702) Access Network Query Protocol, ANQP, information. The ANQP information comprises information elements. The ANQP information is received via the cellular interface from a node in the cellular network. The wireless device then decides (703) whether or not to activate the WLAN interface for the data traffic based on the obtained ANQP information.

### TECHNICAL FIELD

Embodiments herein relate to a wireless device, a node and methods therein. In particular, it relates to deciding whether or not to activate a Wireless Local Area (WLAN) interface.

### BACKGROUND

Wireless devices are also known as e.g. communication devices, User Equipments (UE), mobile terminals, wireless terminals and/or mobile stations. Wireless devices are enabled to communicate wirelessly in a cellular communications network or wireless communication system, sometimes also referred to as a cellular radio system or cellular networks. The communication may be performed e.g. between two wireless devices, between a wireless device and a regular telephone and/or between a wireless devices and a server via a Radio Access Network (RAN) and possibly one or more core networks, comprised in the cellular communications network.

Wireless devices may further be referred to as mobile telephones, cellular telephones, computers, or surf plates with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another wireless devices or a server.

The cellular communications network covers a geographical area which is divided into cell areas, wherein each cell area is served by a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. The cells often overlap each other. Further, each base station may support one or several communication technologies. The base stations communicate over the air interface, also referred to as the cellular interface, operating on radio frequencies with the wireless devices within range of the base stations.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE controlled by the radio base station.

Many devices and wireless devices such as e.g. personal computers, video-game consoles, smartphones, digital cameras, tablet computers and digital audio players may use a Wireless Local Access Networks (WLAN) such as e.g. Wi-Fi. Wi-Fi and WLAN will be used interchangeably in the rest of this document. These may connect to a network resource such as the Internet via a wireless network Access Point (AP) also referred to as a hot spot. Such an AP may have a range of about 20 meters (66 feet) indoors and a greater range outdoors. Hotspot coverage may comprise an area as small as a single room with walls that block radio waves, or as large as many square kilometers achieved by using multiple overlapping access points.

3GPP/WLAN Interworking

Most current WLANs such as Wi-Fi deployments, are totally separate from mobile networks, and may be seen as non-integrated from the terminal perspective. Most operating systems (OSs) for Wireless devices such as Android and iOS support a simple Wi-Fi offloading mechanism where a wireless device immediately switches all its Internet Protocol (IP) traffic to a Wi-Fi network upon a detection of a suitable Wi-Fi network with a received signal strength above a certain level. Henceforth, the decision whether or not to offload to a WLAN network such as a Wi-Fi network is referred to as access selection strategy and the term “Wi-Fi-if-coverage” is used to refer to the aforementioned strategy of selecting Wi-Fi whenever such a network is detected.

There are several drawbacks of the “Wi-Fi-if-coverage” strategy. Though previous pass codes for already accessed Wi-Fi APs can be saved in the wireless device, hotspot login for previously non-accessed APs usually requires user intervention, either by entering a pass code in a Wi-Fi connection manager or using a web interface. The Wi-Fi connection manager is software in a wireless device that is in charge of managing the Wi-Fi network connections of the wireless device, taking into account user preferences, operator preferences, network conditions, etc.

### SUMMARY

It is therefore an object of embodiments herein to provide a more efficient 3GPP/WLAN Interworking in a wireless communications network.

According to a first aspect of embodiments herein, the object is achieved by a method performed by a wireless device for deciding whether or not to activate a Wireless Local Area Network, WLAN, access, interface, WLAN interface, for data traffic. The wireless device comprises a cellular radio access interface towards a node in a cellular network, cellular interface, and the WLAN interface towards an Access Point, AP, in a WLAN. The wireless device receives Access Network Query Protocol, ANQP, information. The ANQP information comprises information elements. The ANQP information is received via the cellular interface from a node in the cellular network. The wireless device then decides whether or not to activate the WLAN interface for the data traffic based on the obtained ANQP information.

According to a second aspect of embodiments herein, the object is achieved by a method performed by a node for assisting a wireless device in deciding whether or not to activate a Wireless Local Area Network, WLAN, access, interface, WLAN Interface, for data traffic. The node operates in a cellular network. The node obtains Access Network Query Protocol, ANQP, information, from the Wireless Local Area Network, WLAN. The ANQP information comprises information elements. The node sends the ANQP information to the wireless device via a cellular radio access interface, cellular interface, between the node and the wireless device. The ANQP information enables the wireless device to decide whether or not to activate the WLAN interface for the data traffic.

According to a third aspect of embodiments herein, the object is achieved by a wireless device for deciding whether or not to activate a Wireless Local Area Network, WLAN, access, interface, WLAN Interface, for data traffic. The wireless device 120 is adapted to comprise a cellular radio access interface towards a node in a cellular network, cellular interface, and the WLAN interface towards an Access Point, AP, in a WLAN, the wireless device is configured to:
Receive Access Network Query Protocol, ANQP, information. The ANQP information comprises information elements. The ANQP information is adapted to be received via the cellular interface from the node in the cellular network, and
Decide whether or not to activate the WLAN interface for the data traffic based on the obtained ANQP information.

According to a forth aspect of embodiments herein, the object is achieved by a node for assisting a wireless device in deciding whether or not to activate a Wireless Local Area Network, WLAN, access, interface, WLAN Interface, for data traffic. The node is adapted to operate in a cellular network. The node is configured to:
Obtain Access Network Query Protocol, ANQP, information, from the Wireless Local Area Network, WLAN, which ANQP information is adapted to comprise information elements, and
Send the ANQP information to the wireless device via a cellular radio access interface, cellular interface, between the node and the wireless device, which ANQP information is adapted to enable the wireless device to decide whether or not to activate the WLAN interface for the data traffic.

Since the ANQP information is reported via the cellular interface a better usage of the radio resources both on the network and on the wireless device side. This results in a more efficient 3GPP/WLAN Interworking in the wireless communications network.

An advantage with embodiments herein is improved battery utilization on the wireless device side as it may be sufficient that it is initially only connected to the cellular network.

Still another advantage with embodiments herein is improved WLAN capacity for user data traffic due to decreased ANQP signalling on WLAN interface.

### BRIEF DESCRIPTION OF THE DRAWINGS

Examples of embodiments herein are described in more detail with reference to attached drawings in which:

FIGS. 1a, b and c are schematic block diagrams illustrating prior art.

FIG. 2 is a schematic block diagram illustrating prior art.

FIG. 3 is a sequence diagram illustrating prior art.

FIG. 4 is a table illustrating prior art.

FIG. 5 is a table illustrating prior art.

FIG. 6 is a schematic block diagram illustrating embodiments herein.

FIG. 7 is a flowchart depicting embodiments of a method in a wireless device.

FIG. 8 is a flowchart depicting embodiments of a method in a node.

FIG. 9 is a sequence diagram illustrating embodiments herein.

FIG. 10 is a sequence diagram illustrating embodiments herein.

FIG. 11 is a schematic block diagram illustrating embodiments of a wireless device.

FIG. 12 is a schematic block diagram illustrating embodiments of a node.

### DETAILED DESCRIPTION

As part of developing embodiments herein, a problem will first be identified and shortly discussed.

3GPP/WLAN Interworking

As mentioned above, most current WLANs such as Wi-Fi deployments, are totally separate from mobile networks, and may be seen as non-integrated from the terminal perspective. Most operating systems (OSs) for Wireless devices such as Android and iOS, support a simple Wi-Fi offloading mechanism where a wireless device immediately switches all its Internet Protocol (IP) traffic to a Wi-Fi network upon a detection of a suitable Wi-Fi network with a received signal strength above a certain level. Henceforth, the decision whether or not to offload to a WLAN network such as a Wi-Fi network is referred to as access selection strategy and the term “Wi-Fi-if-coverage” is used to refer to the aforementioned strategy of selecting Wi-Fi whenever such a network is detected.

There are several drawbacks of the “Wi-Fi-if-coverage” strategy. Though previous pass codes for already accessed Wi-Fi APs can be saved in the wireless device, hotspot login for previously non-accessed APs usually requires user intervention, either by entering a pass code in a Wi-Fi connection manager or using a web interface. The Wi-Fi connection manager is software in a wireless device that is in charge of managing the Wi-Fi network connections of the wireless device, taking into account user preferences, operator preferences, network conditions, etc.

No consideration of expected user experience is made except those considered in proprietary solution implemented in the wireless device, and this can lead to a wireless device being handed over from a high data rate mobile network connection to a low data rate Wi-Fi connection. Even though the Operating System (OS) of the wireless devices or some high level software in the wireless devices is smart enough to make the offload decisions only when the signal level on the Wi-Fi is considerably better than the cellular network link, there can still be limitations on a backhaul of the Wi-Fi AP that may end up being the bottleneck. In a hierarchical telecommunications network the backhaul portion of the network comprises the intermediate links between the core network, or backbone network and the small subnetworks at the “edge” of the entire hierarchical network for example the links connecting the Wi-Fi AP to the rest of the network.

No consideration of the load conditions in the cellular network and Wi-Fi are made. As such, the wireless device may still be offloaded to a Wi-Fi AP that is serving several wireless devices while the cellular network, e.g. LTE that it was previously connected to is rather unloaded.

Interruptions of on-going services can occur due to the change of IP address when the wireless device switches to the Wi-Fi network. For example, a user of a wireless device who started a Voice over IP (VoIP) call while connected to a cellular network is likely to experience a call drop when arriving home and the wireless device switching to the home Wi-Fi network automatically. Though some applications are smart enough to handle this and survive the IP address change, such as e.g. Spotify®, the majority of current applications do not. This places a lot of burden on application developers if they have to ensure service continuity.

No consideration of the wireless device's mobility is made. Due to this, a fast moving wireless device can end up being offloaded to a Wi-Fi AP for a short duration, just to be handed over back to the cellular network. This is specially a problem in scenarios like cafes with open Wi-Fi, where a user of a wireless device walking by or even driving by the cafe might be affected by this. Such ping pong between the Wi-Fi and cellular network can cause service interruptions as well as generate considerable unnecessary signalling, e.g. towards authentication servers.

Recently, Wi-Fi has been subject to increased interest from cellular network operators, not only as an extension to fixed broadband access. The interest is mainly about using the Wi-Fi technology as an extension, or alternative to cellular radio access network technologies to handle the always increasing wireless bandwidth demands. Cellular operators that are currently serving wireless device users with, e.g., any of the 3GPP technologies, LTE, Universal Mobile Telecommunications System (UMTS)/Wideband Code Division Multiple Access (WCDMA), or Global System for Mobile Communications (GSM), see Wi-Fi as a wireless technology that can provide good support in their regular cellular networks. The term “operator-controlled Wi-Fi” points to a Wi-Fi deployment that on some level is integrated with a cellular network operators existing network and where the 3GPP radio access networks and the Wi-Fi wireless access may even be connected to the same core network and provide the same services.

There is currently quite intense activity in the area of operator controlled Wi-Fi in several standardization organizations. In 3GPP, activities to connect Wi-Fi access points to the 3GPP-specified core network are pursued, and in Wi-Fi Alliance (WFA), activities related to certification of Wi-Fi products are undertaken, which to some extent also is driven from the need to make Wi-Fi a viable wireless technology for cellular operators to support high bandwidth offerings in their networks. The term Wi-Fi offload is commonly used and points towards that cellular network operators seek means to offload traffic from their cellular networks to a Wi-Fi network, e.g., in peak-traffic-hours and in situations when the cellular network for one reason or another needs to be off-loaded, e.g., to provide requested quality of service, maximize bandwidth or simply for coverage.

RAN Level Integration

3GPP is currently working on specifying a feature/mechanism for WLAN/3GPP Radio interworking which improves operator control with respect to how a wireless device performs access selection and traffic steering between 3GPP and WLANs belonging to the operator or its partners, it may even be so that the mechanism can be used for other, non-operator, WLANs as well, even though this is not the main target.

It is discussed that for this mechanism the RAN provides assistance parameters that helps the wireless device in the access selection. The RAN assistance information is composed of three main components, namely threshold values, Offloading Preference Indicator (OPI) and WLAN identifiers. The wireless device is also provided with RAN rules and policies that make use of these assistance parameters.

The thresholds values may be for example for metrics such as 3GPP signal related metrics Reference Signal Received Power (RSRP)/Reference Signal Received Quality (RSRQ)/Received Signal Code Power (RSCP)/EcNo, WLAN signal related metrics such as Received Signal Strength Indication (RCPI)/Received Signal Strength Indicator (RSSI), WLAN load/utilization, WLAN backhaul load/capacity, etc. EcNo means received Energy per chip (Ec) of a pilot channel divided by the total Noise power density (No). One example of a RAN rule that uses the threshold value could be that the wireless device should connect to a WLAN if the RSRP is below the signalled RSRP threshold at the same time as the WLAN RCPI is above the signalled RCPI threshold. It is also discussed that the RAN should provide thresholds for when the wireless device should steer traffic back from WLAN to 3GPP. The RAN rules and policies are specified in a 3GPP specification such as TS 36.304 (V12.3.0) and TS 36.331 (V12.4.1).

With the above mechanism it is likely not wanted, or maybe not even feasible, that the wireless device considers any WLAN when deciding where to steer traffic. For example, it may not be feasible that the wireless device uses this mechanism to decide to steer traffic to a WLAN not belonging to the operator. Hence it has been discussed that the RAN should also indicate to the wireless device which WLANs the mechanism should be applied for by sending WLAN identifiers.

The RAN may also provide additional parameters which are used in Access Network Discovery and Selection Function (ANDSF) policies. One proposed parameter is Offloading Preference Indicator (OPI). One possibility for OPI is that it is compared to a threshold in the ANDSF policy to trigger different actions, another possibility is that OPI is used as a pointer to point and select, different parts of the ANDSF policy which would then be used by the terminal.

The RAN assistance parameters, such as e.g. thresholds, WLAN identifiers, OPI, provided by RAN may be provided with dedicated signalling and/or broadcast signalling. Dedicated parameters can only be sent to the terminal when having a valid RRC connection to the 3GPP RAN. A terminal which has received dedicated parameters applies dedicated parameters; otherwise the terminal applies the broadcast parameters. If no RRC connection is established between the terminal and the RAN, the terminal cannot receive dedicated parameters.

In 3GPP, it has been agreed that ANDSF should be enhanced for Release12 to use the thresholds and OPI parameters that are communicated by the RAN to the terminal, and that if enhanced ANDSF policies are provided to the terminal, the terminal will use the ANDSF policies instead of the RAN rules/policies, i.e. ANDSF has precedence.

Tight Integration Between 3GPP and WLAN

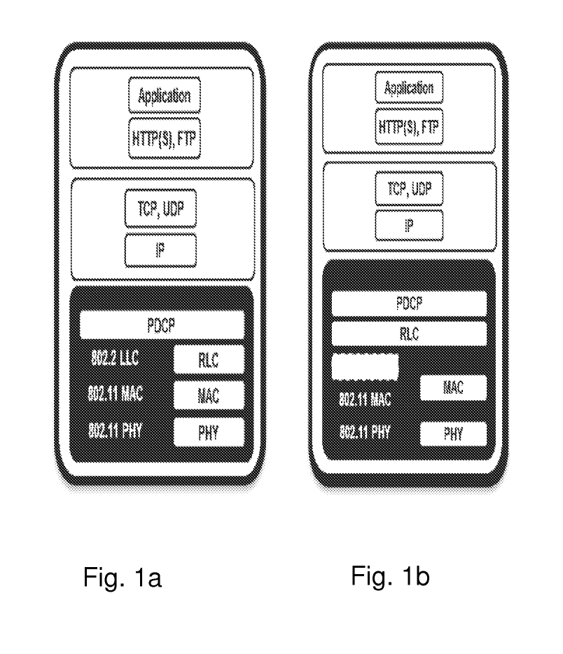

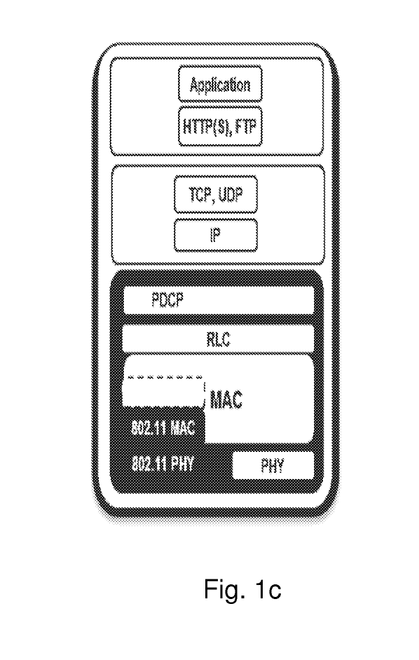

Within the scope of 3GPP rel-13, there has been a growing interest in on realizing even tighter integration/aggregation between 3GPP and WLAN, for example, the same way as carrier aggregation between multiple carriers in 3GPP, where the WLAN is used just as another carrier. Such an aggregation is expected to make it possible for a more optimal aggregation opportunity as compared to MultiPath Transmission Control Protocol (MPTCP), as the aggregation is performed at a lower layer and as such the scheduling and flow control of the data on the WLAN and 3GPP links can be controlled by considering dynamic radio network conditions. FIGS. 1a, b, c illustrate different levels of tight integration/aggregation between 3GPP and WLAN, i.e. three different protocol options of aggregation at the Packet Data Convergence Protocol (PDCP), Radio Link Control (RLC) and Medium Access Control (MAC) levels. FIG. 1a illustrates PDCP aggregation, FIG. 1b illustrates RLC aggregation, and FIG. 1c illustrates MAC aggregation.

The FIGS. 1a, b, c are showing the main principles for these three aggregation levels. Additional functionality may be needed, for example in the PDCP-level aggregation. An additional protocol layer may be used between the PDCP layer and the 802.2 Logical Link Control (LLC) layer to convey information about the terminal and the radio bearer the traffic is associated with.

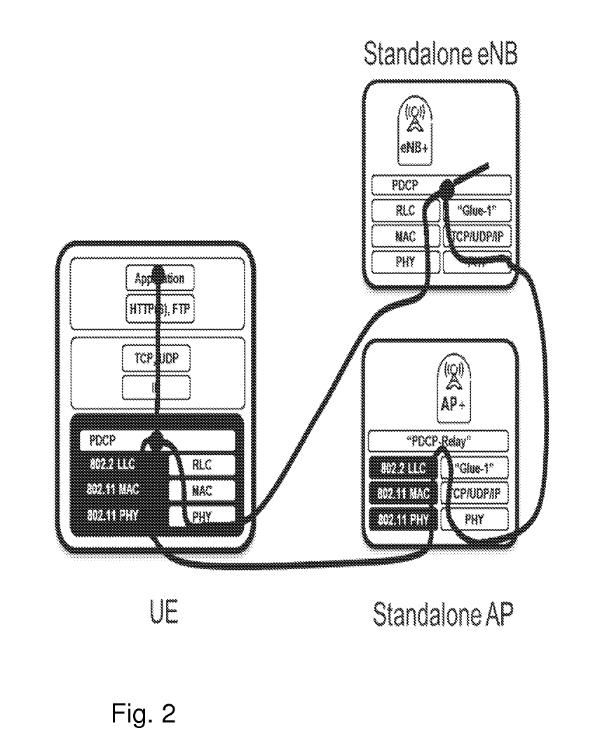

Note that FIGS. 1a, b, c illustrates the protocol stack at a terminal such as a UE, or an integrated/co-located eNB-WLAN AP station. In the case of a standalone AP and eNB, i.e. AP and eNB are non-co-located, the protocol stack for supporting aggregation is a little bit different, as the LLC frames have now to be relayed towards the standalone eNB. FIG. 2 illustrated this for the case of PDCP level aggregation. FIG. 2 depicts PDCP level aggregation with a standalone AP and eNB. In this case, once the LLC packet is decoded at the AP, in the uplink direction from the UE to the AP, and the AP realizes that this packet is a PDCP packet that has to be routed to an eNB, the forwarding can be performed, for example, via Transmission Control Protocol (TCP)/Internet Protocol (IP) protocol stack.

Inter-Node Interface Xw Between 3GPP RAN and WLAN

A study item entitled Multi-RAT Joint Coordination has been recently started in 3GPP TSG RAN3 [3GPP TR 37.870]. At RAN3 #84 the scope and requirements for the Multi-RAT Joint Coordination Study Item (SI) were further defined. In particular, for the 3GPP-WLAN coordination part, it was agreed to focus on non-integrated 3GPP/WLAN nodes since integrated nodes are a matter of implementation.

Among the requirements of the study item [3GPP TR 37.870] it is the investigation of potential enhancements of RAN interfaces and procedures to support the joint operation among different RATs, including WLAN. It has also been agreed that

i. the coordination involving WLAN and 3GPP is in the priority of the study item and

ii. the statements on 3GPP/WLAN must be complementary to RAN2 work [R3-141512].

Based on the recent contributions and offline discussions, this complement could be achieved by the specification of a network interface between the E-UTRAN and WLAN, which may occur in future releases.

The main functionality so far envisioned for this interface, called so far Xw, is the support for traffic steering from LTE to WLAN via the reporting of different sets of information from WLAN to the eNodeB so that educated steering decisions can be taken. However, based on the potential discussions in Release 13 about “tight integration between 3GPP and WLAN”, new functionalities of the Xw interface could be envisioned. Parts of the methods covered by embodiments herein relate to a new functionality of this interface and may either be part of standard enhancements or proprietary solutions.

Access Network Query Protocol

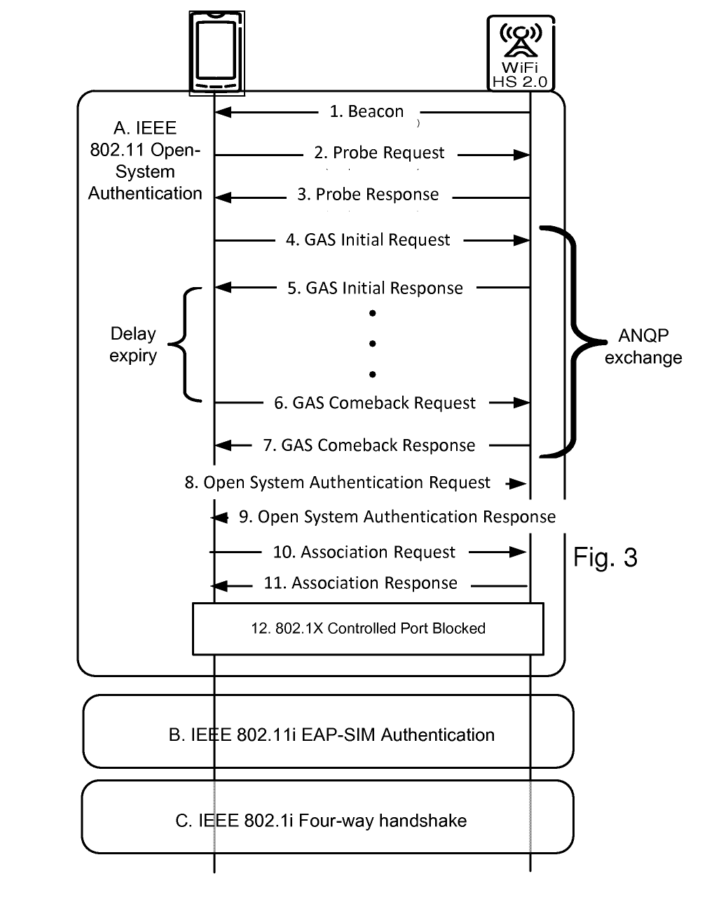

The Access Network Query Protocol, ANQP, is used to provide a mechanism for a WLAN station (STA) such as a wireless device, in a pre-associated state to poll the AP on various types of information i.e., without having to authenticate and associate. The process flow on an ANQP exchange is depicted on FIG. 3. [1] below relates to: Part 11: Wireless LAN Medium Access Control (MAC) and Physical Layer (PHY) Specifications”, IEEE Std. 802.11-2012, IEEE Computer Society. The procedure comprises:

1 The STA receives a Beacon frame, broadcasted by the AP carrying indication that the AP is HotSpot 2.0-enabled. The format of the beacon frame is described in Chapter 8.3.3.2 of IEEE 802.11[1], where the “Vendor Specific” field is used to indicate the HotSpot 2.0 capabilities;

2 If the STA does not receive a Beacon frame for some reason, it can generate a Probe Request and send it to the AP. The Probe Request frame is described in Chapter 8.3.3.9 of IEEE 802.11 [1], and the “Vendor Specific” field carries the indication that the STA is HotSpot 2.0-enabled;

3 The AP answers with Probe Response (Chapter 8.3.3.10 of IEEE 802.11[1]), also indicating that it is HotSpot 2.0-enabled;

4 After the STA recognized that the AP is HotSpot 2.0-enabled, it knows that the AP has Generic Advertisement Service (GAS) capabilities. The STA then generates a GAS Initial Request in order to obtain information about an internetworking service;

5 The AP responds with GAS Initial Response. If the information requested by the STA cannot be fitted into one GAS frame and fragmentation is needed, the AP includes a GAS Query ID and GAS Comeback Delay information. The delay indicates the amount of time that the requesting STA should wait before another GAS Comeback frame exchange can be performed;

6 After the GAS Comeback Delay has expired, the STA sends a GAS Comeback Request (Chapter 8.5.8.14 in IEEE 802.11[1]), requesting the rest of the information. The STA must use the same Query ID, as previously assigned by the AP;

7 The AP responds with GAS Comeback Response (Chapter 8.5.8.15 in IEEE 802.11[1]). Once all the GAS Comeback Response frames have been received (the AP indicates the last fragment by setting the “More GAS Fragments” bit in the Fragment ID field in the GAS Comeback Response to “0”), the STA can defragment and process the information;

a. NOTE 1: In the “Advertisement Protocol Element” field, part of the GAS frame, (described in Chapter 8.5.8.12 of IEEE 802.11 of [1] the STA can include an ANQP query Chapter 8.4.4 of IEEE 802.11[1]). ANQP queries are used to obtain miscellaneous network information, including Network Access Identifier (NAI) Realm, 3GPP Cellular Network Information, etc.;

b. NOTE 2: The AP might forward or proxy the ANQP queries to a backend advertisement server, possibly a 3GPP entity. If the ANQP query requests 3GPP Cellular Network Information, the payload will be a Generic Container. According to the current standards, the only type of information carried is the list of Public Land Mobile Networks (PLMNs), that can be selected from the WLAN and information on which of these PLMNs support S2b connectivity. The support for S2b connectivity indicates whether the wireless device can connect to the PLMN via an evolved Packet Data Gateway (ePDG);

8 The STA sends an Open System Authentication Request as defined in Chapter 11.2.3.2 of IEEE 802.11;

9 The AP responds with an Open System Authentication Response;

10 The STA then sends an Association Request, indicating the security parameters to be used later;

11 The AP responds with an Association Response

a. NOTE: The Open System Authentication does not provide any security. The connection between the STA and the AP is secured at a later point, by means of Authentication and Key Agreement procedure. Nevertheless, a possible attack altering the security parameters in the Open System Authentication message exchange will be detected at the stage of key derivation;

12 At this point the Open System Authentication is completed and the STA can communicate only with the AP—the rest of the traffic is blocked by the PBNC enforcer, as defined in IEEE 802.1X. Some of the traffic towards external hosts, however, can be forwarded by the AP, as in the case of the communication with the RADIUS server;

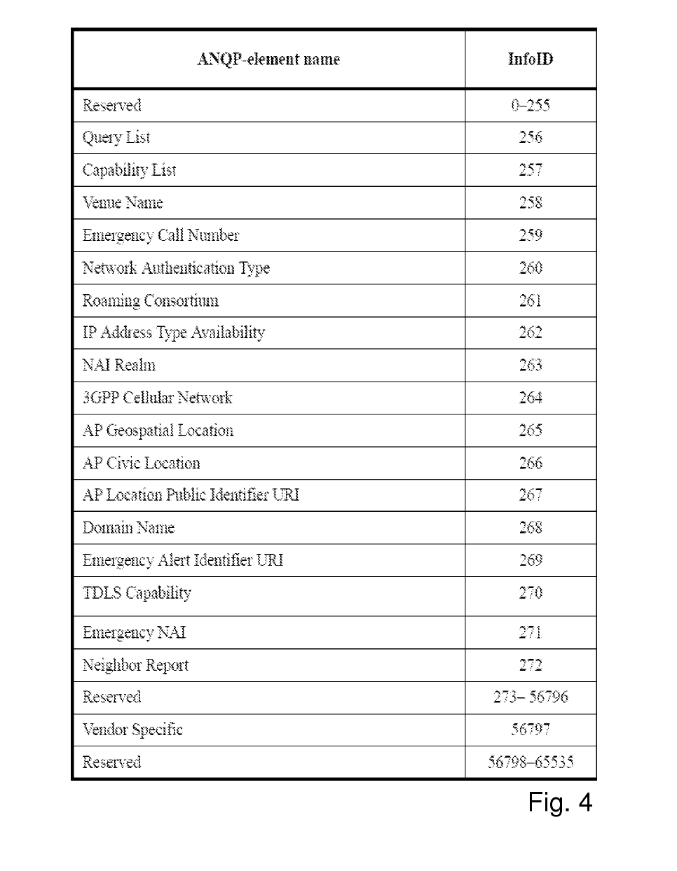

The IEEE 802.11 standard [2] currently defines a number of ANQP elements as shown in FIG. 4 disclosing a list of ANQP elements defined in 802.11u. [2] relates to: Part 11: Wireless LAN Medium Access Control (MAC) and Physical Layer (PHY) Specifications, Amendment 9: Interworking with External Networks, IEEE Std 802.11u™-2011, IEEE Computer Society.

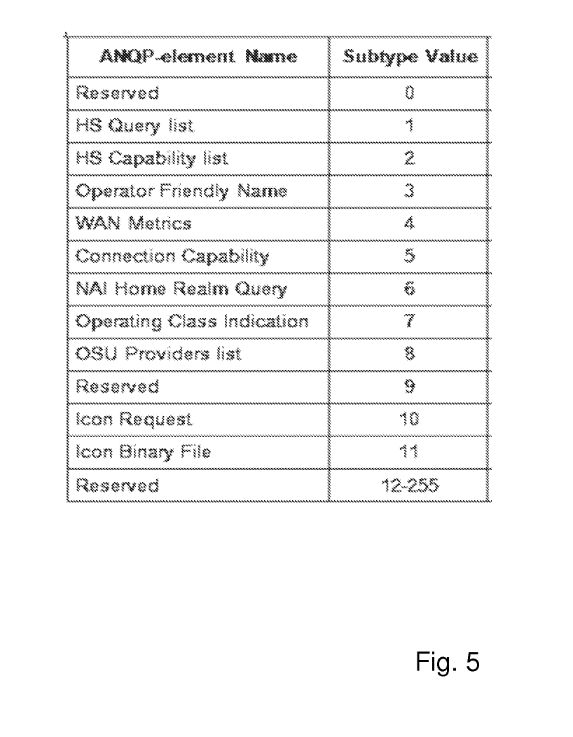

In addition, Hotspot 2.0 [3] defines additional ANQP elements′, as shown in FIG. 5. [3] relates to: Hotspot 2.0, Release 2, Technical Specification, Version 1.0.0, Wi-Fi alliance. The Hotspot 2.0 (HS2.0) ANQP-elements provide additional functionality to the IEEE 802.11 ANQP-elements that support HS2.0 features. The HS2.0 ANQP-elements are formatted as defined by the ANQP vendor-specific element using the InfoID 56797 as shown in FIG. 4 with additional subtype values shown in FIG. 5. FIG. 5 depicts a list of ANQP elements.

Currently ANQP information is delivered via 802.11 pre-association mechanisms, the Generic Advertisement Protocol, as shown in FIG. 3, which is known to be rather inefficient in terms of spectral efficiency. This means that WLAN capacity for user data traffic may be decreased due to ANQP signalling on WLAN interface. The issue can be even more problematic if it is assumed that the 3GPP might be overloaded and using WLAN APs to offload its terminals such as UEs.

Embodiments herein provide delivering ANQP information or portion of it via 3GPP signaling, making a better usage or the radio resources. The wireless device is anyhow camping or connected to the 3GPP RAN and may utilize the existing 3GPP RAN signaling mechanisms to retrieve the ANQP information elements from the 3GPP RAN without the need to perform GAS-signaling towards a Wi-Fi AP. Embodiments herein may also relate to a procedure where 3GPP RAN, e.g. the eNodeB, is informed about ANQP information over an Xw interface or via an Operations, Administration and Maintenance (OAM) configuration, where the OAM node contains WLAN configuration information.

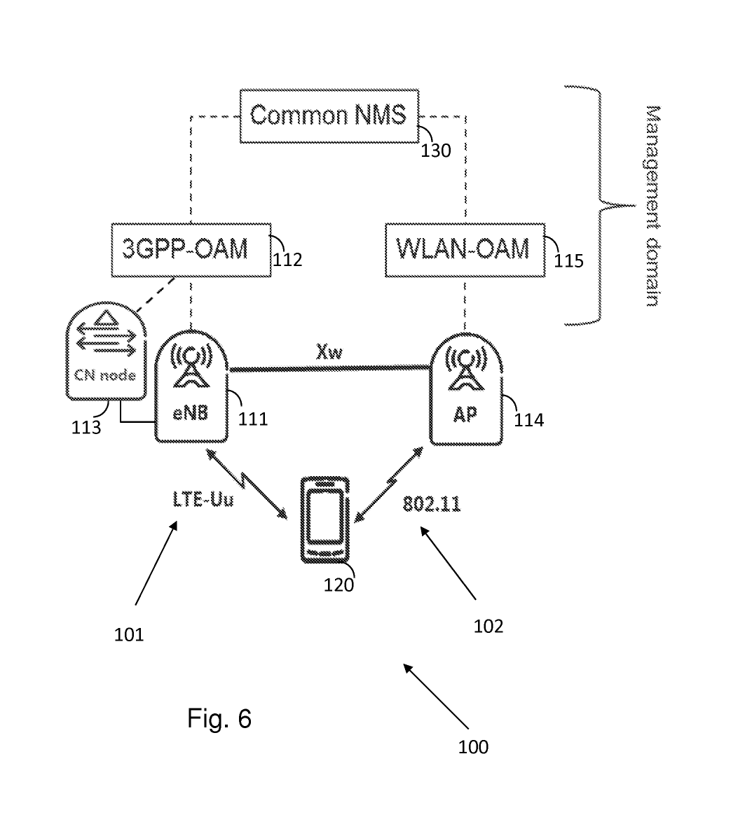

FIG. 6 depicts a wireless communications network 100 also referred to as a communications system, in which embodiments herein may be implemented.

The wireless communications network 100 e.g. comprises a cellular network 101. The cellular network 101 may e.g. be a cellular network defined in 3GPP such as an LTE, a WCDMA, a GSM network or any other 3GPP cellular network. The cellular network 101 may also e.g. be a Wimax, CDMA, CDMA-2000 or any cellular network or system not defined in 3GPP.

The wireless communications network 100 further comprises a WLAN network 102. The WLAN network 102 may e.g. be a WiFi network such as an IEEE 802.11 WiFi network.

The cellular network 101 comprises a plurality of network nodes whereof three, a base station 111, a 3GPP OAM node 112 and a Core Network (CN) node 113 are depicted in FIG. 6.

The base station 111 is a network node which may be for example a Node B, an eNB, an eNodeB, or a Home Node B, a Home eNode B or any other network node capable to serve a wireless terminal in a cellular network.

The CN node 113 is also a network node in the cellular network 101. The CN node 113 may be a core network node such as e.g. an a Serving Gateway (SGW), a PDN Gateway (PGW), a Mobility Management Entity (MME), a Serving GPRS Support Node (SGSN), Gateway GPRS Support Node (GGSN) etc., where GPRS means General Packet Radio Service. The node 113 is typically able to communicate with the wireless device 120 using core network signalling such as any Non-Access Stratum (NAS) signalling.

Note that that the CN node 113 may not have an Xw-interface which means that in this case the only way for the CN node 113 to retrieve ANQP Information is via the 3GPP OAM node 112.

Embodiments herein may be implemented in any of the base station 111 or the CN node 113 in the cellular network 101, and will therefore be referred to as the node 111, 113, meaning any of the base station 111 or the CN node 113. According to embodiments herein, the cellular network 101 is able to provide WLAN ANQP information to the wireless device 120. The cellular network node 111, 113 that provides the ANQP information may e.g. either be a radio node part of the RAN such as a Base Transceiver Station (BTS), a NodeB (NB), an evolved Node B (eNB) or be a core-network node such as a Serving Gateway (SGW), a PDN Gateway (PGW), a Mobility Management Entity (MME), a Serving GPRS Support Node (SGSN), Gateway GPRS Support Node (GGSN) etc., where GPRS means General Packet Radio Service.

WLAN network 102 comprises a plurality of access points whereof one, AP 114 is depicted in FIG. 6. The WLAN network 102 may further comprise a WLAN network node 115 such as a WLAN-OAM node.

Note that the node 111, 113 and the AP 114 may be co-located.

One or more wireless devices operate in the wireless communications network 100, whereof a wireless device 120 is depicted in FIG. 6. The wireless device 120 may be a mobile wireless terminal, a mobile phone, a computer such as e.g. a laptop, or a tablet computer, sometimes referred to as a surf plate, with wireless capabilities, or any other radio network units capable to communicate over a radio link in a cellular communications network 100.

Core network signalling is typically between the CN node 113 and the wireless device 120.

For example, the CN node 113 is connected to the base station 111 for sending of ANQP information to the wireless device 120 and is also connected to the 3GPP OAM node 112 for retrieval of ANQP information.

The wireless device 120 is capable to operate in the cellular network 101 and in the WLAN network 102. The wireless device 120 may be referred to as a Station (STA) when operating in the WLAN network. This is because of the terminology used in WLAN technology. The wireless device 120 is capable of using a cellular radio access interface referred to as the cellular interface, towards the node 111, 113 in the cellular network 101. This interface is referred to as the cellular interface. The wireless device 120 is further capable of using a WLAN interface towards the AP 114 in the WLAN 102.

According to an example scenario the wireless device 120 is capable of communicate with an eNB such the base station 111 over the cellular interface such as e.g. an LTE-Uu interface as depicted in FIG. 6. The wireless device 120 is also capable of communicating with the AP 114 such as a Wi-Fi AP using the WLAN interface which may be an interface relating to IEEE 802.11 protocol. In addition according to some embodiments, there may exist a network side interface, named Xw, as depicted in FIG. 6, between the base station 111 and the AP 114. In a management domain, the base station 111 is connected via an interface to its 3GPP-OAM node which may be node 112, that is capable of configure eNodeB parameters. The AP 114 is also connected via an interface to the WLAN network node 115 such as its WLAN-OAM node. A common Network Management System (NMS) node 130 may have an interface to both 3GPP-OAM and WLAN-OAM nodes so that this common NMS node 130 is able to receive configuration information from both 3GPP-OAM and WLAN-OAM nodes and have access to both nodes base station 111 and the AP 114 in order to configure parameters for example for communication towards the wireless device 120.

Embodiments herein provide methods for delivering the ANQP information or portion of it via 3GPP signaling to the wireless device 120. The wireless device 120 is anyhow camping or connected to the 3GPP RAN and may utilize the existing 3GPP RAN signaling mechanisms to retrieve the ANQP elements from the 3GPP RAN without the need to perform GAS-signaling towards a Wi-Fi AP.

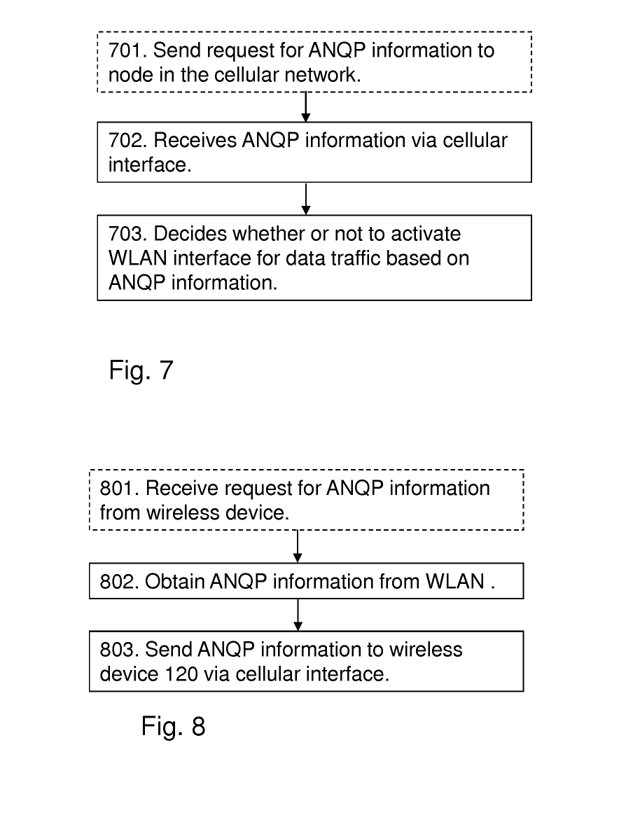

Example embodiments of a method performed by the wireless device 120 for deciding whether or not to activate the WLAN access interface, a so-called WLAN interface, for data traffic, will now be described with reference to a flowchart depicted in FIG. 7. As mentioned above the wireless device 120 comprises a cellular radio access interface towards a node 111, 113 in the cellular network 101, a so-called cellular interface, and the WLAN interface towards the AP 114 in the WLAN 102.

In an example scenario, the wireless device 120 is about to send or receive data traffic, or it prepares for future sending or receiving of data traffic. The method comprises the following actions, which actions may be taken in any suitable order. Dashed lines of one box in FIG. 7 indicate that this action is not mandatory.

Action 701

In some embodiments, the wireless device 120 sends a request for ANQP information to the node 111, 113 in the cellular network 101. The request for ANQP information may be requested explicitly or implicitly. An example of an implicit request is the wireless device 120 sending a measurement report of a certain AP to the node 111,113 without explicitly requesting ANQP information. An example of an explicit request is that the wireless device 120 sends an explicit message to the node 111,113 asking for ANQP information.

The request for ANQP information may e.g. comprise any one or more out of:
information about which AP or APs the request relates to, and
information specifying a specific set of ANQP elements, which it is requested from the node 111, 113 in the cellular network 101.

For example, when the wireless device 120 requests the ANQP information from the node 111, 113, either explicitly or implicitly, it may also define for which APs it is requesting the information. E.g. requesting ANQP information from AP 114, AP1, AP3 and AP4. Another option is for the wireless device 120 to simply request ANQP information and let the node 111, 113 such as e.g. an eNB determine which are the appropriate APs for which the wireless device 120 should receive the ANQP information. In some embodiments of a collocated node 111, 113 and AP 114 deployment, node 111, 113 such as an eNB would only provide the ANQP information related to the collocated AP 114.

In some embodiments, the wireless device 120 specifies a specific set of ANQP elements, which it may request from the node 111, 113. For example, if the wireless device 120 would only like to receive ANQP information regarding 3GPP interworking, then it would request the NAI Realm, the 3GPP Cellular Network, the Domain Name, etc. Then the node 111, 113 can provide only the ANQP elements the wireless device 120 has requested for. The NAI Realm element may identify which networks and/or operators are available via the Wi-Fi AP 114, one example of a NAI Realm is “operator.com”.

In an example embodiment, the sending of the request for ANQP information to the node 111, 113 in the cellular network 101 comprises: Sending a request for a part of the ANQP information to the node 111, 113 in the cellular network 101 and sending a request for another part of the ANQP information to the AP 114.

Action 702

The wireless device 120 receives ANQP information. The ANQP information comprises information elements. The ANQP information elements may e.g. comprise any one or more out of the IEEE 802.11 standard Part 11: Wireless LAN Medium Access Control (MAC) and Physical Layer (PHY) Specifications, Amendment 9: Interworking with External Networks, IEEE Std 802.11u™-2011, IEEE Computer Society. This document defines a number of ANQP elements as shown in FIG. 4. In addition, Hotspot 2.0 Release 2 Technical Specification, Version 1.0.0, Wi-Fi alliance defines additional ANQP elements, as shown in FIG. 5. The HS2.0 specification defines for example how wireless terminals and Wi-Fi APs should function to support access authentication, roaming and subscription provisioning. The Hotspot 2.0 HS2.0 ANQP-elements provide additional functionality to the IEEE 802.11 ANQP-elements that support HS2.0 features. The HS2.0 ANQP-elements are formatted as defined by an ANQP vendor-specific element using the InfoID 56797 as shown in FIG. 4 with additional subtype values as shown in FIG. 5.

For better usage of the radio resources both on the wireless communications network 100 and on the wireless device 120, the ANQP information or in some embodiments at least part of the ANQP information is received via the cellular interface from the node 111, 113 in the cellular network 101. This provides improved battery utilization on the wireless device side as it may be sufficient that it is initially only connected to the cellular network. Still another advantage is improved WLAN capacity for user data traffic due to decreased ANQP signalling on WLAN interface.

The node 111 in the RAN of the cellular network 101 may use broadcast signalling such as e.g. System Information Block (SIB) signalling in order to deliver the information to the wireless device 120. In another embodiment the node 111 in the RAN of the cellular network 101 uses dedicated signalling such as e.g. Radio Resource Control (RRC) signalling in order to deliver the information to the wireless device 120.

In some embodiments, the ANQP information or in some embodiments at least part of the ANQP information is received from the node 111, 113 in the cellular network 101 via any one or more out of: broadcasting, unicasting, 3GPP radio access network signalling and core network signalling. The core network signalling may be any NAS-signalling between the wireless device 120 and the CN node 113.

The ANQP information may comprise an indication to which AP, or group of APs the ANQP information is related to. In an example scenario, when the node 111, 113 in the cellular network 100 delivers the ANQP information to the wireless device 120, either via broadcast or unicast signalling, it also indicates to which AP, or group of APs the ANQP information is related to. The node 111, 113 may identify the AP or set of APs by different identifiers some of which include, Base Service Set identifier (BSSID), Extended Service Set Identification (ESSID), Homogenous Extended Service Set Identifier (HESSID), or a range of those.

In some other embodiments the node 111, 113 in the cellular network 100 delivers the ANQP information for different APs or sets of APs. Where each of the APs or set of APs have different ANQP information associated with them. For example, the node 111, 113 in the cellular network 100 may provide the following to the wireless device 120:
AP1-ANQP1
AP2, AP3, AP4-ANQP2
AP5-AP10-ANQP3

Thus the ANQP information may be an ANQP information out of a set of ANQP information received from the node 111, 113 in the cellular network 100. The set of ANQP information relate to different APs or sets of APs, where each of the APs or set of APs is associated to different ANQP information.

In some embodiments, the wireless device 120 has sent a request for ANQP information to the node 111, 113 in the cellular network 101 according to Action 701. In these embodiments, the ANQP information may be received as a response to the request.

The ANQP information may be received as a response to an action performed by the wireless device 120 towards the base station 110. The action may relate to one or more AP:s including the AP 130. In these embodiments the option would be for the node 111, 113 to provide the ANQP information upon another action by the wireless device 120. E.g., if the wireless device 120 sends a measurement report of a certain AP such as the AP 114 or set of APs, then the node 111, 113 may send the ANQP information related to this AP such as the AP 114, or set of APs to the wireless device 120.

According to embodiments herein the node in the cellular network 101 may provide all or part of the ANQP information to the wireless device 120. In some embodiments the ANQP elements are partitioned into to two different sets of elements: one for cellular network 101 and one for non-cellular network such as the WLAN network 102. If partitioning of the ANQP elements to two different sets of elements is used, the wireless device 120 may ask the AP 114 for the ANQP and then get the WLAN part from the AP 114 and the cellular part from the node 111, 113 in the cellular network 101. The wireless device 120, as mentioned in Action 701, may have sent a request for a part of the ANQP information to the node 111, 113 in the cellular network 101 and a request for another part of the ANQP information to the AP 114. In these embodiments the receiving of the ANQP information comprises: Receiving the part of the ANQP information from the node 111, 113 in the cellular network 101, and receiving said other part of the ANQP information from the AP 114.

Action 703

The wireless device 120 decides whether or not to activate the WLAN interface for the data traffic based on the obtained ANQP information. Note that “based on the obtained ANQP information” herein means “at least partly based on of the obtained ANQP information”. The WLAN interface may e.g. be activated by turning on or off the WLAN access by connecting to a network via the WLAN network 102, or by routing data traffic via the WLAN network 102.

If the ANQP information is concerning only one WLAN AP, that information may be used to decide whether to connect that WLAN AP or not. For example, if the WLAN available backhaul capacity is lower than a certain threshold, the wireless device 120 may abstain from connecting and routing traffic via this WLAN AP. If the acquired ANQP information is concerning more than one WLAN AP, the wireless device 120 may compare the information to decide to connect to one of the WLAN APs, if at all. For example, the wireless device 120 may compare the backhaul by comparing the ANQP information about one or more WLAN APs, and the wireless device 120 may decide to connect and route traffic via the WLAN AP that has the largest available backhaul capacity.

The main advantage is better usage of the radio resources both on the network and on the wireless device 120 side. The reporting of ANQP information via 3GPP may occur right before traffic steering, which may speed up the steering procedure.

Example embodiments of a method performed by the node 111, 113 for assisting the wireless device 120 in deciding whether or not to activate a WLAN Interface for data traffic, will now be described with reference to a flowchart depicted in FIG. 8. As mentioned above, the node 111, 113 operates in the cellular network 101.

Some of the details described in relation to FIG. 8 relates to corresponding details described in relation to FIG. 7 above, where they have been explained more in detail. These details will not be explained again here in relation to FIG. 8. The method comprises the following actions, which actions may be taken in any suitable order. Dashed lines of one box in FIG. 8 indicate that this action is not mandatory.

Action 801

In an example embodiment, the node 111, 113 receives a request for ANQP information from the wireless device 120. The request for ANQP information is requested explicitly or implicitly.

The request for ANQP information may comprise any one or more out of: Information about which AP or APs the request relates to, and information specifying a specific set of ANQP elements, which it is requested from the base station 110.

Action 802

The node 111, 113 obtains ANQP information from the WLAN 102. The ANQP information comprises information elements.

For the node 111, 113 to be able to provide the cellular part of ANQP elements, the node 111, 113 needs to get this information from the AP 114. The node 111, 113 may retrieve this information using the Xw interface as shown in FIG. 6. As mentioned above, the CN node 113 may be connected to the base station 111 for sending of ANQP information to the wireless device 120 and is also connected to the 3GPP OAM node 112 for retrieval of ANQP information. The AP 114 may inform the eNB such as the node 111, about the ANQP parameters in different ways and depending on the nature of the information. If the information is static such as supported capabilities, then it may be provided as part of the establishment of the Xw interface. If the information is more dynamic such as WLAN backhaul load then the AP 114 may provide the information using more dynamic signaling over the Xw interface. This dynamic signaling may be periodic, e.g. once every 5 seconds, or it may be sent based on different thresholds. For example if the information has changed above or below a specific threshold, then the dynamic signaling is used to inform the node 111, 113 about the change.

The information may also be obtained via OAM interfaces 112, 115, where a central node, e.g. placed at the 3GPP Operations & Support System (OSS) or the common NMS 130 for WLAN and 3GPP has up to date information about the ANQP parameters and neighbor APs per eNodeB lists. Then, the OAM node informs e.g. upon request or subscription-based, the eNodeBs such as the node 111, 113 associated to the neighbors WLAN APs their ANQP parameters.

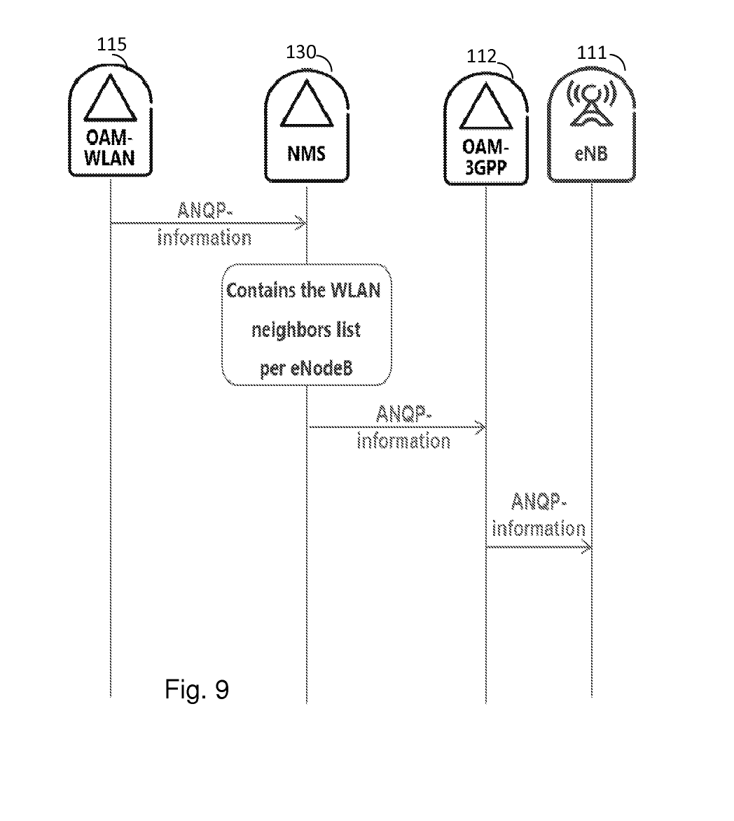

A possible signaling example showing how the eNodeB such as the node 111, 113 obtains the ANQP information about its neighbors is given in FIG. 9.

In some embodiments, the ANQP information comprises an indication to which AP, or group of APs the ANQP information is related to.

The ANQP information may e.g. be an ANQP information out of a set of ANQP information sent to the wireless device 120, which set of ANQP information relate to different APs or sets of APs, where each of the APs or set of APs is associated to different ANQP information.

Action 803

The node 111, 113 sends the ANQP information to the wireless device 120 via the cellular interface between the node 111, 113 and the wireless device 120. The ANQP information enables the wireless device 120 to decide whether or not to activate the WLAN interface for the data traffic.

In the embodiments wherein the node 111, 113 receives the request for ANQP information from the wireless device 120 in Action 801 above, the ANQP information may be sent to the wireless device 120 as a response to the request.

In some embodiments, the ANQP information is sent to the wireless device 120 as a response to an action performed by the wireless device 120 towards the base station 110, which action relates to one or more AP:s including the AP 130.

The ANQP information may be sent to the wireless device 120 through any one or more out of: broadcasting, unicasting, 3GPP radio access network signalling and core network signalling.

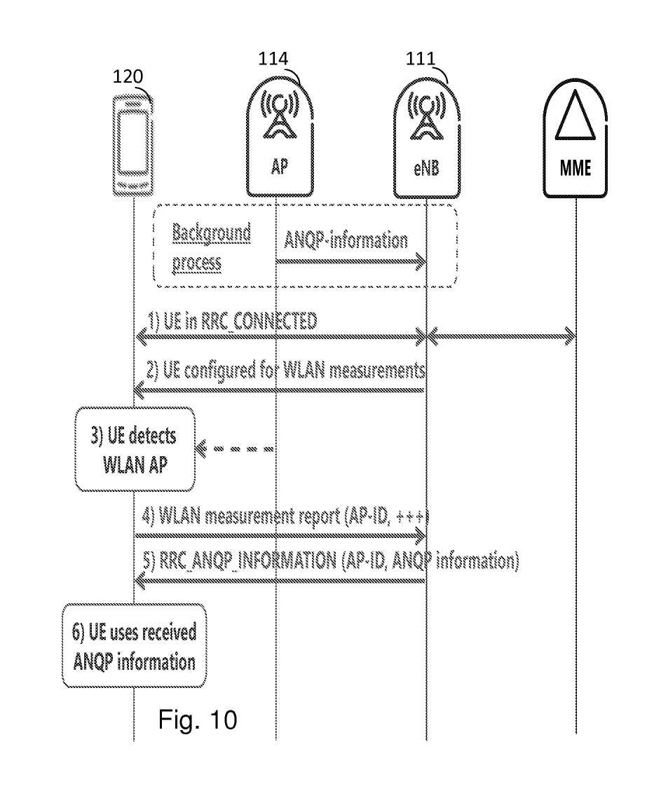

An exemplary signalling flow according to embodiments herein is depicted in FIG. 10. In an example scenario, the wireless device 120 sends a measurement report of detected WLAN AP(s) based on the configuration from the cellular network node such as the base station 111, and based upon this measurement report, the cellular network node 111 responds with the ANQP information of the concerned WLAN AP(s), which are then used by the wireless device network to decide on the activation of the WLAN interface towards a given WLAN AP for data traffic.

As mentioned above, the ANQP elements may be partitioned into to two different sets of elements: one for cellular network 101 and one for non-cellular network such as the WLAN network 102.

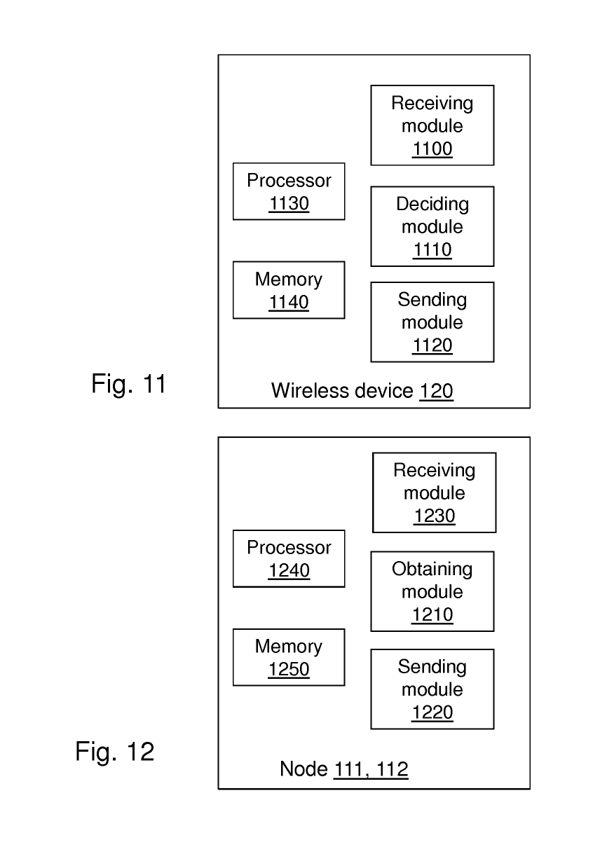

To perform the method actions for deciding whether or not to activate a WLAN access interface, WLAN Interface, for data traffic, described above in relation to FIG. 7, the wireless device 120 may comprise the following arrangement depicted in FIG. 11. As mentioned above the wireless device 120 is adapted to comprise a cellular interface towards a node 111, 113 in the cellular network 101, and the WLAN interface towards the AP114 in a WLAN 102.

The wireless device 120 is configured to, e.g. by means of a receiving module 1100 configured to, receive ANQP information. The ANQP information comprises information elements. The ANQP information is adapted to be received via the cellular interface from the node 111, 113 in the cellular network 101.

The wireless device 120 may further be configured to, e.g. by means of the receiving module 1100 configured to, receive the ANQP information from the node 111, 113 in the cellular network 101 via any one or more out of: broadcasting, unicasting, 3GPP radio access network signalling and core network signalling.

The ANQP information may be adapted to comprise an indication to which AP, or group of APs the ANQP information is related to.

The ANQP information may be adapted to be an ANQP information out of a set of ANQP information received from the node 111, 113 in the cellular network 100. The set of ANQP information relate to different APs or sets of APs, where each of the APs or set of APs is associated to different ANQP information.

The ANQP information may be adapted to be received as a response to a request.

In some embodiments, the wireless device 120 is configured to receive the ANQP information as a response to an action performed by the wireless device 120 towards the base station 110, which action relates to one or more AP:s including the AP 130.

The wireless device 120 is further configured to, e.g. by means of a deciding module 1110 configured to, decide whether or not to activate the WLAN interface for the data traffic based on the obtained ANQP information.

The wireless device 120 is further configured to, e.g. by means of a sending module 1120 configured to, send a request for ANQP information to the node 111, 113 in the cellular network 101, which request for ANQP information is requested explicitly or implicitly.

In some embodiments, the request for ANQP information is adapted to comprise any one or more out of: Information about which AP or APs the request relates to, and information specifying a specific set of ANQP elements, which is requested from the node 111, 113 in the cellular network 101.

In some embodiments, the wireless device 120 further is configured to, e.g. by means of the sending module 1120 configured to, send the request for ANQP information by sending a request for a part of the ANQP information to the node 111, 113 in the cellular network 101 and sending a request for another part of the ANQP information to the AP 114. The wireless device 120 may then be further configured to, e.g. by means of the receiving module 1100 configured to, receive ANQP information by receiving said part of the ANQP information from the node 111, 113 in the cellular network 101, and receiving said other part of the ANQP information from the AP 114.

The embodiments herein comprising the process of deciding whether or not to activate the WLAN interface for data traffic, may be implemented through one or more processors, such as a processor 1130 in the wireless device 120 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into wireless device 120. One such carrier may be in the form of a CD ROM disc. It is however feasible with other data carriers such as a memory stick. The computer program code may furthermore be provided as pure program code on a server and downloaded to the wireless device 120.

The wireless device 120 may further comprise the memory 1140 comprising one or more memory units. The memory 1140 comprises instructions executable by the processor 1130.

The memory 1140 is arranged to be used to store e.g. ANQP information, data, configurations, and applications to perform the methods herein when being executed in the wireless device 120.

Those skilled in the art will also appreciate that the modules in the wireless device 120, described above may refer to a combination of analog and digital circuits, and/or one or more processors configured with software and/or firmware, e.g. stored in the memory 1140, that when executed by the one or more processors such as the processor 1130 as described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

To perform the method actions for assisting a wireless device 120 in deciding whether or not to activate the WLAN access interface, WLAN Interface, for the data traffic in relation to FIG. 8, the node 111, 113 may comprise the following arrangement as depicted in FIG. 12. As mentioned above, the node 111, 113 is adapted to operate in the cellular network 101.

The node 111, 113 is configured to, e.g. by means of an obtaining module 1210 configured to, obtain ANQP information, from the WLAN 102. The ANQP information is adapted to comprise information elements.

The node 111, 113 is further configured to, e.g. by means of an sending module 1220 configured to, send the ANQP information to the wireless device 120 via the cellular radio access interface, the cellular interface, between the node 111, 113 and the wireless device 120. The ANQP information is adapted to enable the wireless device 120 to decide whether or not to activate the WLAN interface for the data traffic.

The node 111, 113 may further be configured to, e.g. by means of the sending module 1220 configured to, send the ANQP information to the wireless device 120 through any one or more out of: broadcasting, unicasting, 3GPP radio access network signalling and core network signalling.

The ANQP information may be adapted to comprise an indication to which AP, or group of APs the ANQP information is related to.

In some embodiments, the ANQP information is adapted to be an ANQP information out of a set of ANQP information sent to the wireless device 120. The set of ANQP information relate to different APs or sets of APs, where each of the APs or set of APs is associated to different ANQP information.

In some embodiments, the node 111, 113 is further configured to, e.g. by means of a receiving module 1230 configured to, receive a request for ANQP information from the wireless device 120. The request for ANQP information is adapted to be requested explicitly or implicitly. The request for ANQP information may be adapted to comprise any one or more out of: Information about which AP or APs the request relates to, and information specifying a specific set of ANQP elements, which it is requested from the base station 110.

In these embodiments, the node 111, 113 may further be configured to, e.g. by means of the sending module 1220 configured to, send the ANQP information to the wireless device 120 as a response to the request.

The node 111, 113 may be adapted to, e.g. by means of the sending module 1220 configured to, send the ANQP information to the wireless device 120 as a response to an action performed by the wireless device 120 towards the base station 110, which action relates to one or more AP:s including the AP 130.

The embodiments herein comprising the process of assisting the wireless device 120 in deciding whether or not to activate the WLAN interface for the data traffic, may be implemented through one or more processors, such as the processor 1240 in the node 111, 113 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the node 111, 113. One such carrier may be in the form of a CD ROM disc. It is however feasible with other data carriers such as a memory stick. The computer program code may furthermore be provided as pure program code on a server and downloaded to the node 111, 113.

The node 111, 113 may further comprise a memory comprising one or more memory units, such as such as the memory 1250 in the node 111, 113 depicted in FIG. 12. The memory 1250 comprises instructions executable by the processor 1240.

The memory 1250 is arranged to be used to store e.g. ANQP information, data, configurations, and applications to perform the methods herein when being executed in the node 111, 113.

Those skilled in the art will also appreciate that the modules in the node 111, 113 described above may refer to a combination of analog and digital circuits, and/or one or more processors configured with software and/or firmware, e.g. stored in the memory 1250 in the node 111, 113 that when executed by the one or more processors such as the processor 1240 as described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1-30. (canceled)

31. A method performed by a wireless device for deciding whether or not to activate a Wireless Local Area Network (WLAN) access interface for data traffic, which wireless device comprises a cellular radio access interface towards a node in a cellular network and the WLAN access interface towards an Access Point (AP) in a WLAN, the method comprising:
receiving Access Network Query Protocol (ANQP) information, which ANQP information comprises information elements, and which ANQP information is received via the cellular radio access interface from a node in the cellular network; and
deciding whether or not to activate the WLAN access interface for the data traffic, based on the obtained ANQP information.

32. The method of claim 31, wherein the ANQP information is received from the node in the cellular network via any one or more out of: broadcasting, unicasting, 3GPP radio access network signaling, and core network signaling.

33. The method of claim 31, wherein the ANQP information comprises an indication to which AP or group of APs the ANQP information is related to.

34. The method of claim 31, wherein the ANQP information is an ANQP information out of a set of ANQP information received from the node in the cellular network, which set of ANQP information relates to different APs or sets of APs, where each of the APs or set of APs is associated to different ANQP information.

35. The method of claim 31, further comprising:
sending a request for ANQP information to the node in the cellular network, which request for ANQP information is requested explicitly or implicitly, and
wherein the ANQP information is received as a response to the request.

36. The method of claim 35, wherein the request for ANQP information comprises any one or more out of:
information about which AP or APs the request relates to, and
information specifying a specific set of ANQP elements that is requested from the node in the cellular network.

37. The method of claim 31, wherein the ANQP information is received as a response to an action performed by the wireless device towards the base station, which action relates to one or more APs including the AP.

38. The method of claim 35, wherein sending a request for ANQP information comprises:
sending a request for a part of the ANQP information to the node in the cellular network and sending a request for another part of the ANQP information to the AP, and
wherein receiving ANQP information comprises: receiving the part of the ANQP information from the node in the cellular network, and receiving said other part of the ANQP information from the AP.

39. A method performed by a node for assisting a wireless device in deciding whether or not to activate a Wireless Local Area Network (WLAN) access interface for data traffic, wherein the node operates in a cellular network, the method comprising:
obtaining Access Network Query Protocol (ANQP) information from the Wireless Local Area Network (WLAN), which ANQP information comprises information elements, and
sending the ANQP information to the wireless device via a cellular radio access interface between the node and the wireless device, which ANQP information enables the wireless device to decide whether or not to activate the WLAN access interface for the data traffic.

40. The method of claim 39, wherein the ANQP information is sent to the wireless device through any one or more out of: broadcasting, unicasting, 3GPP radio access network signaling and core network signaling.

41. The method of claim 39, wherein the ANQP information comprises an indication to which AP or group of APs the ANQP information is related to.

42. The method of claim 39, wherein the ANQP information is an ANQP information out of a set of ANQP information sent to the wireless device, which set of ANQP information relates to different APs or sets of APs, where each of the APs or set of APs is associated to different ANQP information.

43. The method of claim 39, further comprising:
receiving a request for ANQP information from the wireless device, which request for ANQP information is requested explicitly or implicitly, and
wherein the ANQP information is sent to the wireless device as a response to the request.

44. The method of claim 43, wherein request for ANQP information comprises any one or more out of:
information about which AP or APs the request relates to, and
information specifying a specific set of ANQP elements, which it is requested from the base station.

45. The method of claim 39, wherein the ANQP information is sent to the wireless device as a response to an action performed by the wireless device towards the base station, which action relates to one or more APs including the AP.

46. A wireless device for deciding whether or not to activate a Wireless Local Area Network (WLAN) access interface for data traffic, which wireless device is adapted to comprise a cellular radio access interface towards a node in a cellular network and the WLAN access interface towards an Access Point (AP) in a WLAN, the wireless device being configured to:
receive Access Network Query Protocol (ANQP) information, which ANQP information comprises information elements, and which ANQP information is adapted to be received via the cellular radio access interface from the node in the cellular network, and
decide whether or not to activate the WLAN access interface for the data traffic based on the obtained ANQP information.

47. The wireless device of claim 46, wherein the wireless device is configured to receive the ANQP information from the node in the cellular network via any one or more out of: broadcasting, unicasting, 3GPP radio access network signaling and core network signaling.

48. The wireless device of claim 46, wherein the ANQP information is adapted to comprise an indication to which AP or group of APs the ANQP information is related to.

49. The wireless device of claim 46, wherein the ANQP information is adapted to be an ANQP information out of a set of ANQP information received from the node in the cellular network, which set of ANQP information relates to different APs or sets of APs, where each of the APs or set of APs is associated to different ANQP information.

50. The wireless device of claim 46, wherein the wireless device further is configured to:
send a request for ANQP information to the node in the cellular network, which request for ANQP information is requested explicitly or implicitly, and
wherein the ANQP information is adapted to be received as a response to the request.

51. The wireless device of claim 50, wherein request for ANQP information is adapted to comprise any one or more out of:
information about which AP or APs the request relates to, and
information specifying a specific set of ANQP elements that is requested from the node in the cellular network.

52. The wireless device of claim 46, wherein the wireless device is configured to receive the ANQP information as a response to an action performed by the wireless device towards the base station, which action relates to one or more APs including the AP.

53. The wireless device of claim 50,
wherein the wireless device further is configured to send the request for ANQP information by sending a request for a part of the ANQP information to the node in the cellular network and sending a request for another part of the ANQP information to the AP, and
wherein the wireless device further is configured to receive ANQP information by receiving said part of the ANQP information from the node in the cellular network, and receiving said other part of the ANQP information from the AP.

54. A node for assisting a wireless device in deciding whether or not to activate a Wireless Local Area Network (WLAN) access interface for data traffic, wherein the node is adapted to operate in a cellular network, wherein the node is configured to:
obtain Access Network Query Protocol (ANQP) information from the Wireless Local Area Network (WLAN), which ANQP information is adapted to comprise information elements, and
send the ANQP information to the wireless device via a cellular radio access interface between the node and the wireless device, which ANQP information is adapted to enable the wireless device to decide whether or not to activate the WLAN access interface for the data traffic.

55. The node of claim 54, wherein the node is configured to send the ANQP information to the wireless device through any one or more out of: broadcasting, unicasting, 3GPP radio access network signaling and core network signaling.

56. The node of claim 54, wherein the ANQP information is adapted to comprise an indication to which AP or group of APs the ANQP information is related to.

57. The node of claim 54, wherein the ANQP information is adapted to be an ANQP information out of a set of ANQP information sent to the wireless device, which set of ANQP information relate to different APs or sets of APs, where each of the APs or set of APs is associated to different ANQP information.

58. The node of claim 54, further being configured to:
receive a request for ANQP information from the wireless device, which request for ANQP information is adapted to be requested explicitly or implicitly, and
wherein the node is configured to send the ANQP information to the wireless device as a response to the request.

59. The node of claim 58, wherein request for ANQP information is adapted to comprise any one or more out of:
information about which AP or APs the request relates to, and
information specifying a specific set of ANQP elements that is requested from the base station.

60. The node of claim 54, wherein the node is adapted to send the ANQP information to the wireless device as a response to an action performed by the wireless device towards the base station, which action relates to one or more APs including the AP.
